(19) United States
(12) Patent Application Publication
(10) Pub. No.: US 2015/0075057 A1
(43) Pub. Date: Mar. 19, 2015

(54) CONTAINER FOR THE DELIVERY AND DISTRIBUTION OF THE LURE OR FOOD OR PHARMACEUTICAL SUBSTANCE FOR FISH OR FOR THE DISSOLUTION OF THE SUBSTANCE IN THE AQUATIC ENVIRONMENT

(71) Applicant: Vadim KORUNSKY, (US)

(72) Inventor: Vadim Korunsky, Kievskaya obl. (UA)

(21) Appl. No.: 14/400,236

(22) PCT Filed: Dec. 28, 2012
(86) PCT No.: PCT/UA2012/000120

§ 371 Date: Nov. 10, 2014

(30) Foreign Application Priority Data
Dec. 19, 2012 (UA) 2012 14584

(51) Int. Cl. A01K 85/01; A01K 97/06; A01K 97/02

(52) U.S. Cl. CPC A01K 85/01; A01K 97/02; A01K 97/06
USPC 43/42.06

(57) ABSTRACT

The “Karpela cont” container for the delivery and distribution of the lure or food or pharmaceutical substance for fish or for the dissolution of the substance in the aquatic environment, comprises a casing made of water-resistant, predominantly, polymeric material, which consists of at least, two parts (1) connected with one another by split connection, creating an internal cavity. Each part has, at least, two holes or groups of holes (7). The holes are located on the opposite surfaces of the casing, moreover, the total area of holes makes up from 5% to 50% of the total area of the container's surface. Using the structural and other features of the “Karpela cont” container, the delivery and distribution of the lure or food or the pharmaceutical substance for fish or the substance to be dissolved in the aquatic environment is ensured, simultaneously securing the protracted release of the above container's contents into the aquatic environment, augmenting the universality and ease of use of the container, as well as increasing the manufacturability of the container with the above-mentioned features.

The invention can be used in the fishing sector for the delivery and distribution of the lure or food in the aquatic environment during the fishing by a fishing rod, spinning rod or other fishing tackle. Also, the invention can be used in the fish breeding sector, in particular, for the aquarium care, delivery and distribution of pharmaceutical substance for the aquarium population. Likewise, the invention can be used in the sanitary and hygienic equipment sector for the delivery and distribution of the substance to be dissolved in the aquatic environment, for example, in a bathtub.

The applicant knows about many containers for the delivery and distribution of the lure or food or pharmaceutical substance for fish or the dissolution of the substance in the aquatic environment, among which the closest, on the basis of total dominant features, are the following.

A container is known to be used as a fish feeder, which consists of a spring casing fixed on a rod located inside the spring along its longitudinal axis. The spring casing has a barrel-like or cone shape. At least, on one end of the tubular or solid rod an additional attachment fitting is mounted in the shape of a ring, which is fastened to the rod (Patent UA 33916 U, published on Jul. 25, 2008, Bulletin No. 14, 2008, A01K 97/00).

The disadvantage of the known container is the casing design in the form of a spring which creates limitations for using it for different types of the container's contents.

Also, a container is known under Patent RU 122 247 U1, published on Nov. 27, 2012, Bulletin No. 33, A01K 97/00, which is used as a feeder for fishing in the stream. The container has a casing made of the polymeric material in the shape of a hollow cutaway cone with holes and fields on the external surface and an additional metal load located inside the casing in the upper part of the cone. The mass of the load can be changed depending on the conditions of the aquatic environment, where the container is used. The fastening to the tackle is made through a ring with a swivel secured in the lower section of the casing.

The disadvantage of the known container is the lack of means to ensure the longitudinal release of the container's contents, which results in a need to frequently change the contents and a need to use an additional load, thus complicating the casing design and the container's use. Also, its disadvantage is the lack of possibility to use the container not only as a feeder, but also as a lure or bait, which reduces the universality of its use.

Also, a container is known which is used as a fishing lure, having a hollow casing for the lure. Inside the hollow part of the casing there is a rod which consists of the water-resistant enclosure open from both ends and a spongy core. The lure is located inside the spongy core of the rod (Utility Model Certificate RU 38536 U1, published on Jul. 10, 2004, A01K85/01, A01K97/04).

The disadvantage of this container consists in its ability to release the lure substance from the ends of the spongy core only. Also, such a container design complicates the preparation of the lure for use, as well as creates limitations for using other lure types or other type of the container's contents.

Also, a container is known for the delivery and distribution of the lure during the fishing according to Patent JP 2000224946, published on Aug. 15, 2000, A01K97/04; A01K97/05), which has a spherical body and a cover equipped with round holes for release of the lure into the aquatic environment. In the bottom part of the body there is a skirt, consisting of a set of leaves made with a possibility of wrapping up the surface of the body and closing the holes to make it impossible for the lure to get out when the container is on the surface and a possibility of lowering the leaves down when the container is in the water and releasing the lure through the holes. Also, in its bottom part the container has the facilities for fastening it to the fishing and other auxiliary tackle for the delivery of the container into the aquatic environment.

Such a container has the means that make it impossible for the contents to get into the aquatic environment, but these means do not ensure the continuous lure release to the water. Also, the container does not provide a possibility to be used as a lure, thus reducing its universality of use. Also, the design of the container's tackle fastening facilities for its delivery to the aquatic environment additionally limits the sphere of its use.

Also, a float container is known made in a shape of a hollow casing, having holes in its bottom part for releasing the substance with a certain smell, for example, as a lure for fish. Locating such substance is achieved through locating the material saturated with the substance in the hollow of the casing. The release of the substance is ensured by pressing the saturated material with a plate under the influence from outside and turning the plate backwards. The adjustment of the release is carried out manually with the help of shutters on the outer surface of the casing (U.S. Pat. No. 4,799,328, published on Jan. 24, 1989, A01K93/00).

The disadvantage of the known container consists in the impossibility to use it at any depth of the aquatic environment, relative complexity of the mechanism of the substance release and the need for manual adjustment of the release. Also, the known container, due to the design features can not be used as a lure or a bite, which creates limitations for its use.

Also, a container is known for the delivery and distribution of the lure or food for fish, which comprises a casing made of water-resistant, predominantly polymeric material that consists of two parts connected with one another by split connection, creating an internal cavity. In the cavity there is a central channel with the openings located on the opposite surfaces of the casing. In addition, the channel has holes for communication with the internal cavity of the casing for gradual release of the container's contents into the aquatic environment (Patent U.S. Pat. No. 7,043,870, published on May 16, 2006, A01K97/02).

The disadvantage of the known container is the release of the container's contents through one channel, which can result in its clogging and lead to the stoppage of the release. Also, the mentioned releasing mechanism limits the type of the contents that can be delivered to the aquatic environment.

Also, the containers are known for the delivery and distribution of the lure for fish in the aquatic environment that have a casing made in the shape of bait such as fish, mollusks and so on (U.S. Pat. No. 6,675,525, published on Jan. 13, 2004, A01K85/01, Patent application US 2003/0126785 A1, published on Jun. 10, 2003, A01K85/00). The design of these containers in the shape of bait provides for the availability of hooks to be caught by fish, internal cavities for locating and releasing the lure or substances with the smell and tackle fastening facilities.

The disadvantage of such kind of containers is that they are predominantly disposable and ensure the lure release only under the effect of the water apprise flow when the container is moved by the tackle.

Also, the containers are known that release the lure or other substance as affected by the water current while they rotate in the motion provided by the tackle (U.S. Pat. No. 7,520,086 B2, published on Apr. 21, 2009, A01K85/01, A01K97/02, Patent Application US 2004/0068916 A1, published on Apr. 15, 2004, A01 K97/02). Such containers have a casing consisting of the two parts separated lengthwise and crosswise of the lateral surface to be located inside the cavity of the lure casing. On the surface of the casing there are holes for releasing the lure. The facilities for ensuring the rotation of the casing under the influence of the water current during the motion of the container in the water are located on both butt ends of the casing or on its surface. The motion of the container is ensured by the tackle, for connecting with which there are the facilities that are located on both ends of the container.

The disadvantage of the described containers is the possibility of the lure release only during the motion in the aquatic environment, ensuring which also complicates the container's design. Moreover, containers can be used only as a feeder or as part of the lure that in a certain manner limits their use.

Also, a container is known to comprise a casing made of the two parts that can be rotated upon a common axis and a possibility of the container to close. The cavity of the container is intended to place special tablets inside with a substance to be pressed out through the holes on the surface of the container when the container's parts close. The container in connected to the fishing facilities (tackle) for it to get into the aquatic environment with the help of plastic casings of certain shapes depending on the fishing methods, having a corresponding opening for the container and tackle fastening facilities (Patent Application US 2006/0005456 A1, published on Jan. 12, 2006, A01K85/01).

The disadvantage of the known container is the casing design, leading to the need to use the substance to be distributed in a special form for placing in the hollow, use additional plastic casings for the container to get into the necessary environment and the lack of facilities for protracted release of the contents into the aquatic environment.

As a prototype, a container for the delivery and distribution of the lure for fish was taken with a casing consisting of the two hemispheres with a cavity for placing the lure (substance). One of the hemispheres has tackle fastening facilities for the container to be delivered into the aquatic environment, and the other hemisphere has holes for filling the cavity with the lure, a part of them is closed with rubber bands to avoid early opening before the container gets into the aquatic environment, and comprises through holes for the protracted lure release that are smaller in size than are the filling holes (U.S. Pat. No. 5,428,921, published on Jun. 4, 1995, A01 K97/02).

The disadvantage of the prototype is a possibility of reduced universality of its use caused by the design of the tackle fastening facilities, and also a relatively low efficiency of the protracted lure release of the contents caused by the existence of just one hole with a special shape in the bottom part of the casing's hemisphere.

The basis for the invention was the task to ensure the delivery and distribution of the lure or food or pharmaceutical substance for fish or the substance to be dissolved in the aquatic environment and simultaneous protracted release of the mentioned container's contents into the aquatic environment by changing the design and the material of the container's contents. The additional task of the invention is to enhance the container's universality and ease of use through equipping the casing with fastening facilities that do not go beyond the casing's confines, and to increase the manufacturability of the container with the features mentioned above.

The assigned task is performed in such a way that the “Karpela cont” container for the delivery and distribution of the lure or food or pharmaceutical substance for fish or for the dissolution of the substance in the aquatic environment, comprises a casing made of water-resistant, predominantly, polymeric material, which consists of, at least, two parts connected with one another by split connection, creating an internal cavity; each part has, at least, two holes or groups of holes, and, according to the invention, the holes are located on the opposite surfaces of the casing, moreover, the total area of holes makes up from 5% to 50% of the total area of the container's surface.

The total area of holes predominantly makes up from 8% to 20% of the total area of the container's surface.

The casing's material mainly has the density that differs by not more than 10% from the water density.

Additionally, parts of the casing's surface can be made spherical.

Additionally, the casing's parts can be connected with one another with threaded connection.

Additionally, the holes or groups of holes can be made in different shapes.

Additionally, the container can comprise a tackle fastening facility, which represents, at least, two coaxial holes located on the surfaces of the casings' parts. Moreover, coaxial fastening holes can be made with a larger diameter than the majority of holes of the group.

Additionally, parts of the casing can be made in different colors.

Between the total dominant features and the technical result to be achieved there is the following cause-and-effect relation.

To determine the peculiarities of the container's design, which ensure the delivery of the substance or other contents of the container to the aquatic environment with subsequent protracted release of the contents in the aquatic environment, the inventor carried out a number of experiments, during which containers were tested with different location of holes in the casing, different diameters of holes and different materials of the casing.

Determining optimal correlation of the total area of holes and total area of the container was carried out for spherical containers with round and ellipsoidal holes in sweet (river) water and sea water. To do so, a series of containers was taken with different diameters (10, 14 and 22 mm) and different correlation value of the total area of holes and total surface area of the container (from 2 to 80%). The mentioned containers had holes placed on the opposite surfaces of the parts of the casings. At that the state of the container's contents was periodically researched for the velocity of its release to the aquatic environment up until before its complete release with the fixation of approximate time of such release. The optimal time for complete release of the contents was approximately 1-2 hours. The results of the experiment are given in the table.

In this manner, according to the tabular data, the inventor experimentally established that the optimal correlation of the total hole area to the total surface area of the container for ensuring the protracted release of the container's contents in the water of various densities is from 5% to 50% of the total surface area of the container.

Thus, it was established that the connection of such conditions as the location of holes on the opposite surfaces of the casings' parts and the correlation of the total holes area and the total surface area of the container between 5% and 50% makes it possible to ensure the delivery and distribution of the lure or food or pharmaceutical substance for fish and simultaneous protracted release of the mentioned container's contents into the aquatic environment.

The most optimal is the correlation of the total hole area and the total surface area of the container is between 8 and 20%.

Also, it was experimentally determined that the use of the casing's material with a density that differs not more than 10% from the water density is necessary to ensure the zero buoyancy of the container with the contents.

The casing's parts made in the spherical shape augments the universality of use of the container and increases is manufacturability, as well as it is optimal for ensuring the threaded connection of the container parts.

The threaded connection of the parts of the container's casing is optimal from the point of view of connection reliability, connection ease while using the container and interchangeability of the container's parts.

Making holes on the parts of the casing in different shapes makes it possible to increase the universality of use of the containers by ensuring the interchangeability of parts of the container, as well as additionally enhances the container's versatility while using the container for different sizes of contents types and enables to use the container as a feeder.

Making the tackle fastening facilities in the shape of, at least, two coaxial holes located on the surfaces of the parts of the casings allows to increase the universality of use of the container both for the delivery and distribution of the lure or food and for the pharmaceutical substance for fish and the substance to be dissolved in the aquatic environment, as well as additionally increase the fastening reliability of the casing to the fishing line or snood when using the container for fishing.

Making fastening holes of larger diameter than the majority ion the group makes it possible to ensure fastening to the tackle elements different in diameter (fishing line, snood), and also to ensure a more precise visual differentiation of the purpose of holes, which additionally increases the ease of use of the container.

Making the parts of the casing in different colors enables to create the sets of different color containers, additionally enhancing the attractiveness of their use as a lure or bait and augmenting the universality of their use as a part of the set.

To explain the essence of the invention, below is given the example of a specific use of the “Karpela cont” container illustrated with drawings. The drawings, explaining the invention, and also the given example, showing a specific version of the device, will in no way limit the scope of statements put forth in the Claims, but jest explain the essence of the invention.

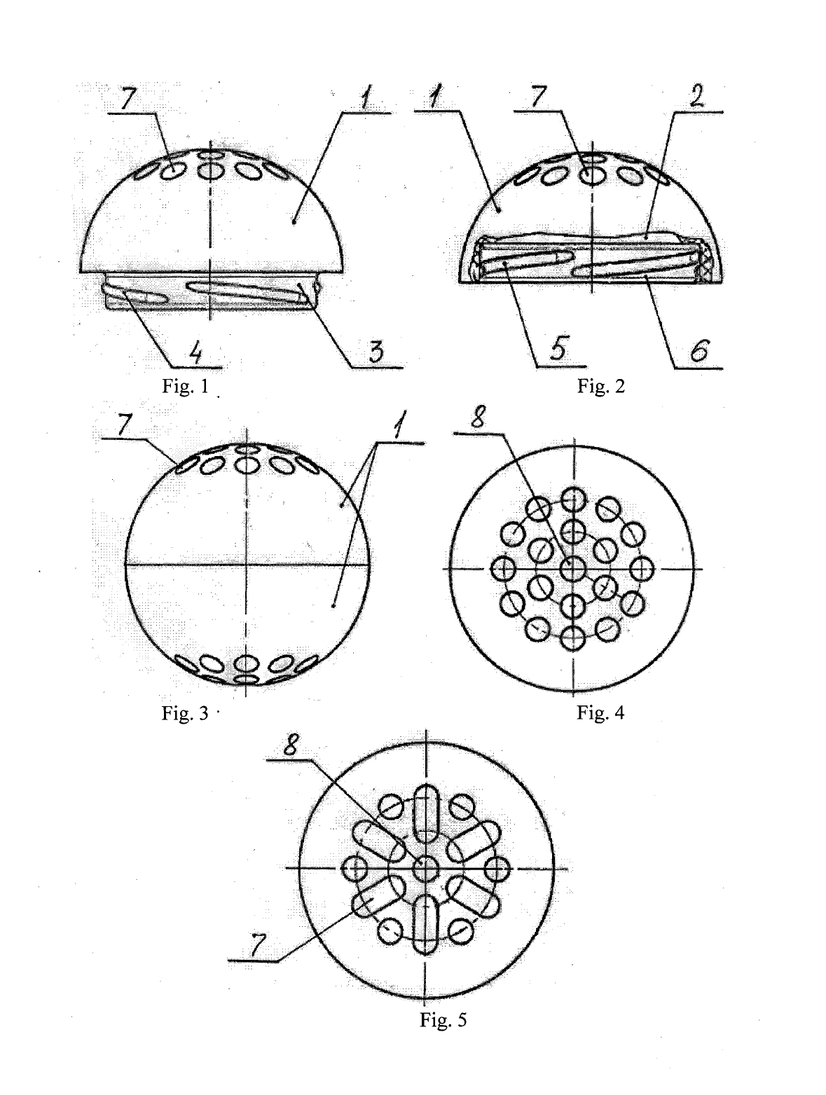

FIG. 1. General view of the casing's part of the container with projection,

FIG. 2. General view of the casing's part of the container with groove,

FIG. 3. General view of the container assembly,

FIG. 4. Top view of the container with holes of the same shape,

FIG. 5. General view of the container with holes of different shapes,

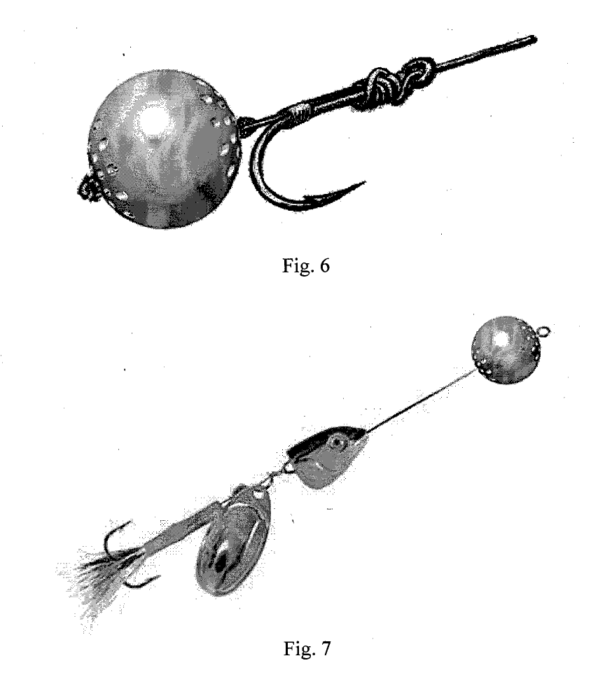

FIG. 6, FIG. 7. Example of the “Karpela cont” container used for fishing.

The “Karpela cont” container comprises a casing with two detachable spherical parts 1 and a cavity 2. On one spherical part 1. there is a cylindrical projection 3, on the outer surface of which the thread is made 4, which corresponds to the thread 5 on the internal surface of the cylindrical groove 6 of the other spherical part 1.

Each spherical part 1 has a group of holes 7, located on the opposite surfaces as a chord to the surface of the spherical part. The total area of holes makes up from 5% to 50% of the total surface area of the container. For example, for a spherical container 10 mm in diameter the total hole area can be 30 mm², thus, on each spherical part 1 up to 19 holes 1 mm in diameter can be located.

Additionally, the spherical part 1 comprises two coaxial holes 8, located on the surfaces of the parts of the casings, which are used as a tackle fastening facility that can be have a larger diameter than the holes 7.

On FIG. 5 a “Karpela cont” container is shown with holes of different shape (round and ellipsoidal).

The casing's material can be predominantly water-resistant with the density differing not more than 10% from the water density. For example, in sweet water with a density of 1,000 kg/m³ or sea water with a density of more than 1,000 kg/m³ (usually 1,030 kg/m³) polypropylene with a density between 900 and 910 kg/m³ (according to GOST 26996-86) is mainly used for making containers.

The spherical parts 1 can be made in different colors to increase their attractiveness as bait or lure during the fishing.

Also, the parts of the casing 1, except for those with a spherical surface, can be made with a surface of a different geometrical shape equipped with corresponding split connection facilities, and also have the parts made in different shapes, for example, one part can be cylindrical and the other part can have a half-ellipsoidal shape, which can be connected with split connection.

The “Karpela cont” container is used as follows:

At first the spherical part 1 or both parts are filled with a lure or food or pharmaceutical substance for fish or the substance to be dissolved in the aquatic environment (for example, salts in a bathtub). Afterwards, the connection of the spherical parts is made using the thread connection.

Then, if used for fishing, the casing is fastened to the line or metallic snood of the fishing tackle through, for example, holes 8. In particular, if the container is used as a lure or bait, the container is fastened to the snood right after the fishing hook (FIG. 6) or spoon-bait. If the container is used as a feeder, it is fastened before the fishing hood or spoon-bait (FIG. 7) or to a separate tackle depending on the type of fishing.

After the delivery of the container to the aquatic environment its contents is gradually released through holes 7 under the influence of motion of the aquatic environment, which is ensured by fishing tackle itself or natural flow of the aquatic environment or the contact of the aquatic environment with the container's contents.

Also, it is possible to create the sets of containers of different sizes, for example, in case of spherical shape, from 10 mm to 22 mm, which can also have holes 7 different in shape. Moreover, in case of using color parts of the container, it is possible to use the connection of the parts in different colors to additionally increase the attractiveness of the container as a lure or bait.

Also, the sizes of the containers from the set can be chosen to ensure the placement of each smaller container inside the bigger container to enhance the ease of their transportation, storage and use.

Also, it is possible to use several containers consecutively or in parallel at the same time in the fishing tackle and different places, which also augments the universality of their use.

While using the container for the delivery and distribution of the pharmaceutical substance for fish or substances for dissolution in the aquatic environment, the parts of the container are filled and connected as described above and the container is placed in the aquarium or bathtub respectively, whereupon the container starts floating loosely in the aquatic environment, releasing the contents due to the contact with the water that gets inside the container's cavity.

In this manner, due to the design and other peculiarities of the “Karpela cont” container, the delivery and distribution of the lure or food or pharmaceutical substance for fish or the substance to be dissolved in the aquatic environment are ensured, as well as the protracted release of the mentioned container's contents in the aquatic environment, increased universality and ease of use of the container and enhanced manufacturability of the container with the above features.

1. The “Karpela cont” container for the delivery and distribution of the lure or food or pharmaceutical substance for fish or for the dissolution of the substance in the aquatic environment, comprises a casing made of water-resistant, predominantly, polymeric material, which consists of, at least, two parts connected with one another by split connection, creating an internal cavity, each part having, at least, two holes or groups of holes, characterized in that the holes are located on the opposite surfaces of the casing and the total area of holes makes up from 5% to 50% of the total area of the container's surface.

2. The “Karpela cont” container according to claim 1, characterized in that the total area of holes makes from 8% to 20% of the total area of the container surface.

3. The “Karpela cont” container according to claim 1, characterized in that the casing's material has the density that differs by not more that 10% from the water density.

4. The “Karpela cont” container according to in claim 1, characterized in that the parts of the casing's surface are made spherical.

5. The “Karpela cont” container according to claim 1, characterized in that the parts of the casing are connected with one another by threaded connection.

6. The “Karpela cont” container according to claim 1, characterized in that the holes or groups of holes are made in different shapes.

7. The “Karpela cont” container according to claim 1, characterized in that the container has a fastening facility to the tackle, which represents, at least, two coaxial holes located on the surfaces of the casings' parts.

8. The “Karpela cont” container according to claim 1, characterized in that the casing's parts are made in different colors.
